(19) United States
(12) Patent Application Publication
(10) Pub. No.: US 2020/0378243 A1
(43) Pub. Date: Dec. 3, 2020

(54) METHOD OF MODELLING A SEDIMENTARY BASIN BY TAKING AT LEAST ONE DOMINANT MIGRATION MECHANISM INTO ACCOUNT

(71) Applicant: IFP Energies nouvelles, Rueil-Malmaison Cedex (FR)

(72) Inventors: Renaud TRABY, RUEIL-MALMAISON CEDEX (FR); Sylvie PEGAZ-FIORNET, RUEIL-MALMAISON CEDEX (FR); Sylvie WOLF, RUEIL-MALMAISON CEDEX (FR); Isabelle FAILLE, RUEIL-MALMAISON CEDEX (FR); Francoise WILLIEN, RUEIL-MALMAISON CEDEX (FR); Mathieu DUCROS, RUEIL-MALMAISON CEDEX (FR)

(21) Appl. No.: 16/884,491

(22) Filed: May 27, 2020

(30) Foreign Application Priority Data
May 27, 2019 (FR) 19/05.606

(51) Int. Cl. E21B 47/10; G06F 30/28

(52) U.S. Cl. CPC E21B 47/10; G06F 2113/08; G06F 30/28

(57) ABSTRACT

The invention relates to a method of determining a dominant hydrocarbon migration mechanism in a sedimentary basin, using a numerical basin simulation simulating a hydrocarbon migration according to at least two migration mechanisms and measurements of physical quantities performed in the basin. A numerical basin simulation and a gridded representations of different states is used to determine a contribution of each hydrocarbon migration mechanism for each state for the cells of the gridded representation of this state.

### CROSS-REFERENCE TO RELATED APPLICATIONS

Reference is made to French Patent Application No. 19/05.606, filed May 27, 2019, the contents of which are incorporated herein by reference in their entirety.

### BACKGROUND OF THE INVENTION

### Field of the Invention

The present invention relates to the exploration and to the development of petroleum reservoirs or geological gas storage sites.

### Description of the Prior Art

Petroleum exploration seeks hydrocarbon reservoirs within a sedimentary basin. Understanding the principles of hydrocarbon genesis and the connections thereof with the subsurface geological history has allowed development of methods for assessing the petroleum potential of a sedimentary basin.

The general procedure for assessing the petroleum potential of a sedimentary basin comprises shuttles between:
a prediction of the petroleum potential of the sedimentary basin, from available data relative to the basin being studied (outcrops, seismic surveys, drilling data for example). The goal of this prediction is to better understand the architecture and the geological history of the basin being studied, notably to study whether hydrocarbon maturation and migration processes may have taken place, to identify the subsurface zones where these hydrocarbons may have accumulated, to define which zones have the best economic potential, evaluated from the volume and the nature of the hydrocarbons probably trapped (viscosity, rate of mixing with water, chemical composition, etc.), as well as their operating cost (controlled for example by the fluid pressure and depth),
exploratory drilling operations in the various zones having the best potential, in order to confirm or invalidate the previously predicted potential and to acquire new data intended to spur new and more precise studies.

Petroleum development of a reservoir proceeds from the data collected during the petroleum exploration phase, to selection of the reservoir zones with the best petroleum potential, defining optimum development schemes for these zones (using reservoir simulation for example to define numbers and positions of the development wells allowing optimum hydrocarbon recovery), drilling development wells and, in general terms, setting up production infrastructures necessary for reservoir development.

In sedimentary basins which have undergone a complicated geological history or when the volume of data is very large, petroleum potential assessment of a sedimentary basin requires computer tools allowing synthesis of the available data, as well as computer tools allowing simulation of the geological history and of the many physical processes that govern it. This procedure is referred to as “basin modelling”. The family of softwares referred to as basin modelling softwares allows simulation in one, two or three dimensions of the sedimentary, tectonic, thermal, hydrodynamic, organic and inorganic chemical processes involved in the formation of a petroleum basin. Basin modelling conventionally comprises three steps:
a step of constructing a gridded representation of the basin being studied, known as geomodelling. This gridded representation is most often structured in layers, in which a group of cells is assigned to each geological layer of the modelled basin. Then, each cell of this gridded representation is filled with one or more petrophysical properties, such as porosity, facies (clay, sand, etc.) or their organic matter content at the time of their sedimentation. The construction of this model is based on data acquired through seismic surveys, measurements while drilling, core drilling, etc.;
a structural reconstruction of the gridded representation representing prior to states of the basin architecture. This step can be carried out using a method referred to as backstripping or to a method referred to as structural restoration;
a numerical simulation of physical phenomena taking place during the basin evolution and contributing to the formation of oil traps. This step, known as basin simulation, is based on a discretized representation of space and time for reconstructing the basin formation through geological times. In particular, basin simulation allows simulation, through geological times, the formation of hydrocarbons from notably the organic matter initially buried with the sediments, and the transport of these hydrocarbons, known as migration, from the rocks in which they are formed to those where they are trapped. Basin simulation thus provides a map of the subsoil at the current time, showing the probable location of the reservoirs, as well as the proportion, the nature and the pressure of the hydrocarbons trapped therein.

Thus, this integrated procedure allows the phenomena that have caused hydrocarbon generation, migration and accumulation in sedimentary basins to be taken into account and analysed which increases the success rate when drilling an exploration well, thus enabling better development of this basin.

The following documents are mentioned in the description hereafter:
Carruthers, Transport of Secondary Oil Migration Using Gradient-Driven Invasion Percolation Techniques. PhD Thesis, Heriot-Watt University, Edinburgh, Scotland, UK, 1998.
Schneider F., Modelling Multi-Phase Flow of Petroleum at the Sedimentary Basin Scale. Journal of Geochemical exploration 78-79 (2003) 693-696.
Steckler, M. S., and A. B. Watts, Subsidence of the Atlantic-Type Continental Margin off New York, Earth Planet. Sci. Lett., 41, 1-13, 1978.
Sylta, Modeling of Secondary Migration and Entrapment of a Multicomponent Hydrocarbon Mixture Using Equation of State and Ray-Tracing Modeling Techniques, Petroleum Migration, Geological Society, Special publication no 59, pp. 111-112, 1991.

Basin simulation tools allowing the formation of a sedimentary basin to be numerically simulated are known, such as the tool described in patent EP-2,110,686 corresponding to U.S. Pat. No. 8,150,669, or in patent applications EP-2,816,377 corresponding to US published patent application 2014/0,377,872, EP-3,075,947 corresponding to US published patent application 2016/0,290,107, and EP-3,182,176 corresponding to US published patent application 2017/0,177,764. These tools notably allow assessment of the evolution of quantities such as temperature and pressure in an entire sedimentary basin through geological times, and thus simulate, through geological times, both the conversion of the organic matter present in a source rock of the basin into hydrocarbons and the migration of these hydrocarbons produced in a reservoir rock of the basin.

FIG. 1 shows a schematic representation of a sedimentary basin comprising a source rock RM in which hydrocarbons are generated through maturation, two reservoir rocks RR in which the hydrocarbons generated accumulate in form of oil O and/or gas G, a cap rock RC and possible examples, shown in form of arrows, of migration paths followed by the hydrocarbons between source rock RM and reservoir rocks RR.

In general terms, the mechanisms involved in the migration of hydrocarbons may vary significantly from one sedimentary basin to the other. Hydrocarbons generally originate from the conversion of organic matter to hydrocarbon fluids under the effect of a thermal stress. After generation, the hydrocarbon fluids can flow freely through the pore network formed by the rocks. Having generally a lower density than water, which largely saturates the rock, they will tend to rise progressively to the surface under the effect of Archimedes' principle of buoyancy. However, capillary forces and hydrodynamic forces represent two other forces that may affect the direction of migration of the hydrocarbons. Moreover, the porosity and permeability heterogeneities will also play a significant role regarding the rate and direction of migration of the hydrocarbons.

The various hydrocarbon migration mechanisms in a basin can be modelled, for example in cases where the hydrocarbons are present in a single phase and the reference phase selected is the water phase, by means of the law known as the generalized Darcy's law, as described hereafter. However, the generalized Darcy's law allows being informed of the displacement rate of the hydrocarbons and of their displacement paths in the sedimentary basin. On the other hand, applying this law does not allow knowing the geological and physical mechanism(s) responsible for the displacement of hydrocarbons, let alone the respective contributions thereof.

Now, knowing the respective contributions of the various hydrocarbon migration mechanisms in a sedimentary basin may contribute to a better understanding of how the petroleum system works, and thus to more accurately assess the petroleum potential of a basin. Indeed, the migration mode of hydrocarbons formed by maturation of a source rock may potentially greatly influence the displacement rates and therefore distances, as well as the types of trap in which the hydrocarbons may accumulate. Thus, hydrocarbons that would be displaced by buoyancy only, that is whose movement would be induced by the density differential, would concentrate within structural traps (such as anticlines) encountered on the migration paths. On the other hand, if the hydrocarbon fluids are predominantly displaced due to the pressure gradient, lateral migrations may be expected over very long distances (hundreds of kilometers for example) and filling of the structural traps would be more difficult due to hydrodynamic forces.

Furthermore, knowing the type of dominant hydrocarbon migration mechanism for a sedimentary basin can allow reducing the duration of a survey of the basin as a whole. Indeed, several numerical basin simulations are commonly performed during the exploration phase of this basin. Now, basin simulation is costly in terms of computing time and computer memory used, notably for simulating the hydrocarbon migration in the sedimentary basin.

In general terms, a basin simulation is launched from simulation parameters that are often estimated from hypotheses on the basin formation history. The basin simulation result, which notably comprises a picture of the basin at the current time, is then compared with the real knowledge acquired on the basin at the current time, this knowledge resulting from direct measurements in the basin. If too significant differences appear between prediction through simulation and observations, a new basin simulation is usually launched by modifying the simulation parameters until a convergence is obtained between simulation and observations. However, the number of numerical basin simulations actually launched is sometimes limited in practice due to the significant computing time required by a numerical basin simulation. But a limited number of basin simulations can reduce the chances of success during the hydrocarbon exploitation phase in this basin.

Moreover, it is common to have new data relative to the basin during the basin exploration phase. For example, it may be new data provided by a new exploration well, new measurements in wells, better knowledge of the organic matter present in the source rock of the basin, etc. In principle, a new basin simulation should be launched in order to take this new data into account and to enable better prediction of the petroleum potential of this basin. A new basin simulation is however not always systematically launched due to the significant computing time required for basin simulation, which may be detrimental to the chances of success of the hydrocarbon exploitation of this basin.

### SUMMARY OF THE INVENTION

The present invention allows these drawbacks to be overcome. More particularly, the present invention allows determination of the respective contributions of the various hydrocarbon migration mechanisms in a sedimentary basin. In addition to contributing to a better analysis of the petroleum potential of a basin, knowledge of the dominant hydrocarbon migration mechanism in a sedimentary basin can allow selection of a simplified and therefore cheaper hydrocarbon migration simulation method (such as the ray tracing method or the invasion percolation method).

Reducing the computing time of the basin simulation allows launching a basin simulation multiple times during the exploration phase of this basin, and thus to better predict the petroleum potential of this basin. The invention therefore contributes to better knowledge of the basin being studied, thus allowing exploitation of the hydrocarbons in this basin to be improved.

The present invention relates to a computer-implemented method of determining a dominant hydrocarbon migration mechanism in a sedimentary basin, the sedimentary basin having undergone geological events defining a sequence of states of the basin, the sequence of states comprising the state of the basin at the current time and at least one state of the basin at a prior geological time, by use of a computer-performed numerical basin simulation, the numerical basin simulation simulating at least one migration of the hydrocarbons in the basin according to at least two migration mechanisms.

The method according to the invention comprises carrying out, through data processing means, at least the following steps:

A) performing measurements of physical quantities relative to the basin by sensors and construction of a gridded representation representative of the basin for the state of the basin at the current time;

B) from the gridded representation of the basin for the state of the basin at the current time, constructing a gridded representation of the basin for each of the states of the basin at the prior geological times;

C) by use of the numerical basin simulation and of the gridded representations for each of the states, determining, for each of the states and in each of the cells of the gridded representation of the state, the contribution of the migration mechanisms of the hydrocarbons in the cell for the state;

D) deducing therefrom at least one dominant migration mechanism of the hydrocarbons for at least one set of cells of at least one gridded representation of the basin for at least one of the states.

According to an implementation of the invention, the migration mechanism can be induced by at least one of hydrodynamic forces, capillary forces, and buoyancy.

According to an implementation of the invention, the numerical basin simulation can implement a generalized Darcy's equation to simulate the migration of the hydrocarbons in the basin, and the generalized Darcy's equation can be expressed with a formula of the type:

$$U = \frac{- K , kr}{μ} [ grad ( P - ρ w gz ) + grad ( Pc ) - ( ρ w - ρ ) g \cdot grad ( z ) ]$$

where U is the rate of displacement of a hydrocarbon phase, K is an intrinsic water permeability, μ is a fluid viscosity, kr is the relative permeability of the medium to the hydrocarbon phase, P is a pressure of the water phase, ρw is the water density, ρ is the density of the hydrocarbon phase, z is the depth, Pc is the capillary pressure and g is the gravitational acceleration.

According to an implementation of the invention, the contribution of one of the migration mechanisms induced by the hydrodynamic forces can be expressed with a formula of the type:

CH=grad(P−ρ_{w}gz)/U.

According to an implementation of the invention, the contribution of one of the migration mechanisms induced by the capillary forces can be expressed with a formula of the type:

CC=grad(P_{c})/U.

According to an implementation of the invention, the contribution of one of the migration mechanisms induced by the buoyancy can be expressed with a formula of the type:

CF=(ρ_{w}−ρ)g·grad(z)/U.

Furthermore, the invention relates to a computer program product downloadable from at least one of a communication network, recorded on a computer-readable medium and processor executable, comprising program code instructions for implementing the method as described above, when the program is executed on a computer.

The invention further relates to a method of exploiting hydrocarbons present in a sedimentary basin, the method comprising at least implementing the computer-implemented method of determining a dominant hydrocarbon migration mechanism in the basin as described above and wherein, from at least the dominant hydrocarbon migration mechanism, a scheme for developing the basin comprising determining at least one site for at least one injection well and/or at least one production well, and the hydrocarbons of the basin are exploited at least by drilling the wells of the site and by providing them with exploitation infrastructures.

According to an implementation of the invention, from at least the dominant hydrocarbon migration mechanism, at least the following steps can further be carried out:
a) using a numerical basin simulation suited for simulating a migration of the hydrocarbons in the basin according to the dominant migration mechanism and from parameters of the basin simulation, determining basin simulation results as a function of the parameters of the basin simulation;
b) measuring differences between at least part of the results of the basin simulation at the current time and at least part of the measurements of the physical quantities;
c) reiterating steps a) and b) until the differences are below a predetermined threshold, with the parameters of the basin simulation being modified at each of the iterations of the reiteration steps,
   and, additionally, from at least part of the results of the basin simulation determining the development scheme of the basin.

### BRIEF DESCRIPTION OF THE DRAWINGS

Other features and advantages of the method according to the invention will be clear from reading the description hereafter of embodiments given by way of non limitative example, with reference to the accompanying figs. wherein:

FIG. 1 schematically shows a sedimentary basin comprising a source rock, two reservoir rocks and potential migration paths;

FIG. 2 shows an example of a sedimentary basin (left) and an example of a gridded representation (right) of this basin; and

FIG. 3 shows an example of structural reconstruction of a sedimentary basin according to an embodiment of the invention, represented by three deformation states at three different geological states.

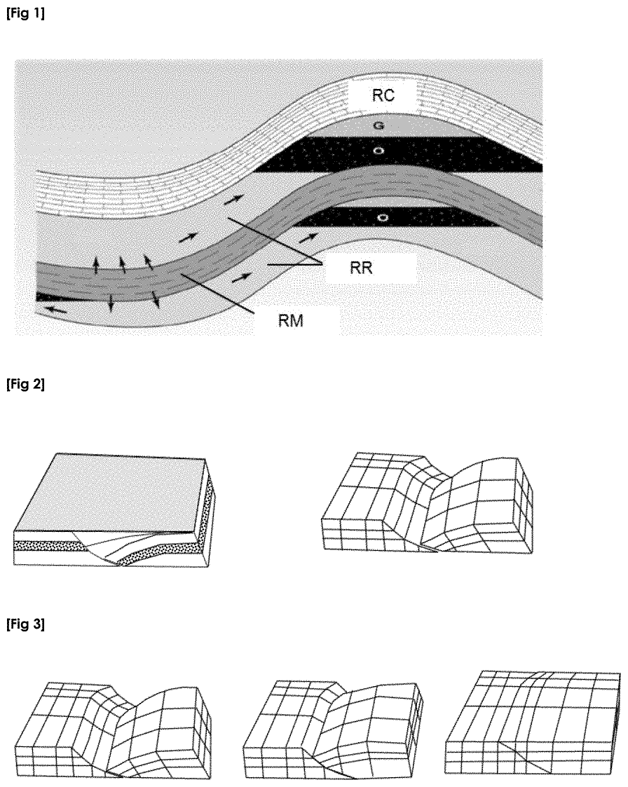

### DETAILED DESCRIPTION OF THE INVENTION

According to a first aspect, the invention relates to a computer-implemented method of determining a dominant hydrocarbon migration mechanism in a sedimentary basin. According to the invention, it is assumed that the sedimentary basin has undergone geological events defining a sequence of states of the basin, each of the states stretching between two successive geological events. Preferably, the sequence of states can cover a period of time covering at least the production of hydrocarbons, notably through maturation of an organic matter present in a source rock of the basin and the displacement of these hydrocarbons produced towards at least one reservoir rock of the basin through geological times. In the description hereafter, by way of non-limitative example, a state of the sequence of states of the basin is denoted by Ai, i with being an integer ranging from 1 to n, and An representing the state of the basin at the current time. According to the invention, the value of n is at least 2. In other words, the sequence of states according to the invention comprises the state of the basin at the current time and at least one state of the basin at a prior geological time.

The present invention is implemented by use of a computer-performed numerical basin simulation allowing at least simulation of the hydrocarbon migration in the basin by at least two hydrocarbon migration mechanisms. According to a preferred implementation of the invention, the numerical basin simulation uses the generalized Darcy's equation for modelling the hydrocarbon migration in the basin as described hereafter.

According to a second aspect, the invention relates to a method for exploiting the hydrocarbons present in a sedimentary basin, the method according to the second aspect comprising implementing the method of determining a dominant hydrocarbon migration mechanism in a basin according to the first aspect of the invention.

The method of determining a dominant hydrocarbon migration mechanism in a basin according to the invention comprises at least steps 1 to 4 described hereafter.

The method of exploiting hydrocarbons present in a sedimentary basin according to the invention further comprises at least step 6 described hereafter, and preferably steps 5 and 6 described hereafter.

### 1. Measurement of Physical Quantities Relative to the Basin

This step acquires measurements of physical quantities relative to the basin being studied, by use of sensors.

By way of non-limitative example, the sensors can be logging tools, seismic sources and receivers, fluid samplers and analyzers, etc.

Thus, the measurements according to the invention can be outcrop surveys, seismic acquisition surveys, measurements in wells (well logging for example), and at least one of petrophysical and geochemical analyses of cores taken in situ.

Petrophysical properties associated with the basin being studied, such as facies (lithology), porosity, permeability or the organic matter content at some measurement points of the basin can be deduced from these measurements. Information on the properties of the fluids present in the basin, such as values of the saturation in different fluids present in the basin, can also be obtained. Furthermore, temperatures can be measured at various points in the basin (notably bottomhole temperatures).

### 2. Construction of a Gridded Representation Representative of the Basin in the Current State

This step constructs a gridded representation representative of the basin in the current state, from measurements of physical quantities performed in the previous step.

More precisely, constructing a gridded representation of a basin discretizes in three dimensions the basin architecture and assigns properties to each cell of this gridded representation. Physical quantities measured at various points of the basin as described above are therefore notably exploited and at least one extrapolated and interpolated, in the different cells of the gridded representation, according to more or less restrictive hypotheses.

In most cases, spatial discretization of a sedimentary basin is organized in cell layers representing each the various geological layers of the basin being studied. FIG. 2 illustrates, on the left, an example of a sedimentary basin at the current time and, on the right, an example of a gridded representation of this basin.

According to an implementation of the invention, the gridded representation for the current state An of the basin notably comprises, in each cell, a datum on the lithology, a porosity value, a permeability value, an organic matter content, and properties relative to the fluids present in the cell, such as saturation.

### 3. Structural Reconstruction of the Basin Architecture for the Various States

This step reconstructs past architectures of the basin for the various states Ai, with i ranging from 1 to n−1. The gridded representation constructed in the previous step, which represents the basin at the current time, is therefore deformed in order to represent the anti-chronological evolution of the subsoil architecture over geological times, and for the various states Ai. A gridded representation is thus obtained at the end of this step for each state Ai, with i ranging from 1 to n.

According to a first embodiment of the present invention, structural reconstruction can be particularly simple if it is based on the hypothesis that the deformation thereof results only from a combination of vertical movements through sediment compaction or through uplift or downwarp of the basement thereof. This technique, known as backstripping, is described for example in (Steckler and Watts, 1978).

According to another embodiment of the present invention, in the case of basins whose tectonic history is complex, notably basins with faults, it is advisable to use techniques with less restrictive hypotheses, such as structural restoration. Structural restoration is for example described in document FR-2,930,350 A1 corresponds to US published patent application 2009/0,265,152 A1. Structural restoration calculates the successive deformations undergone by the basin, by integrating the deformations due to compaction and those resulting from tectonic forces.

In the example of FIG. 3, three states are used to represent the subsoil deformation over geological times. The gridded representation on the left shows the current state, where a slip interface (a fault here) can be observed. The gridded representation on the right shows the same sedimentary basin for a state Ai, prior to the current state. For this state Ai, the sedimentary layers are not fractured. The central gridded representation is an intermediate state, representing the sedimentary basin in a state Ai′ contained between state Ai and the current state. It can be seen that the slip event along the fault has started to modify the basin architecture.

### 4. Numerical Basin Simulation and Determination of a Dominant Migration Mechanism

This step constructs a basin model for each state Ai, by use of a numerical basin simulation of at least the hydrocarbon migration in the basin according to at least two migration mechanisms.

In general terms, a numerical basin simulation (or simulator) is a software executed on a computer, allowing a basin simulation to be performed numerically. More precisely, a numerical basin simulation allows numerical simulation of evolution (including genesis and migration) of the fluids (hydrocarbons, but also formation water) within the basin being studied, of their properties (evolution of the fluid pressures, saturations and temperatures), and of the petrophysical properties of the rocks that make up the sedimentary layers of the basin studied (notably porosity and permeability).

The basin simulation according to the invention is performed by use of a numerical basin simulation applied to the sequence of states Ai of the basin. According to the invention, the basin simulator requires gridded representations of the basin for each state Ai of the basin as described above.

Generally, basin simulation solves a system of differential equations describing the evolution over time of the physical quantities being studied. A discretization technique such as the finite volume method can therefore be used for example, as described for example in (Scheichl et al., 2003). According to the principle of the cell-centered finite volume methods, the unknowns are discretized by a constant value per cell and the (mass or heat) conservation equations are integrated in space for each cell and in time between two successive states Ai. The discrete equations then express that the quantity conserved in a cell in a given state Ai is equal to the quantity contained in the cell in the prior state Ai−1, increased by the flux of quantities that have entered the cell and decreased by the flux of quantities that have left the cell through its faces, plus external supplies.

Conventionally, for each state Ai and in each cell of the gridded representation of the basin for the state Ai being considered, the basin simulator allows at least determination of the following physical quantities: rates and directions of displacement of fluids present in the basin. Furthermore, in an implicit and conventional manner in basin simulation, the following quantities are further determined for each state Ai and in each cell of the gridded representation of the basin for the state Ai being considered: temperature, pressure and amount of hydrocarbons.

The TemisFlow® software (IFP Energies nouvelles, France) is an example of such a basin simulator.

The numerical basin simulation according to the invention allows simulation of the migration of the hydrocarbons in the basin according to at least two migration mechanisms. According to the invention, a contribution of each migration mechanism is determined, for each state Ai and in each cell of the gridded representation of the basin for the state Ai considered.

Preferably, the basin simulation according to the invention implements the generalized Darcy's equation, which is well-known, which can be written in the form:

$$U = \frac{- K , kr}{μ} [ grad ( P - ρ w gz ) + grad ( Pc ) - ( ρ w - ρ ) g \cdot grad ( z ) ] \qquad ( 1 )$$

where U is the rate of displacement of the hydrocarbon phase in the medium, K is the intrinsic water permeability of the medium, μ is the fluid viscosity, kr is the relative permeability of the medium to the hydrocarbon phase, P is the pressure of the water phase, ρw is the water density, ρ is the density of the hydrocarbon phase being considered, z is the depth, Pc is the capillary pressure of the rock and g is the gravitational acceleration. The generalized Darcy's equation allows simulation of the hydrocarbon migration according to three migration mechanisms: hydrodynamic forces, capillarity and buoyancy. On the other hand, Darcy's law does not allow simulation of a transport of hydrocarbons in form of gas dissolved in pore water (advective transport).

According to this preferred implementation of the invention, for each state Ai and in each cell of the gridded representation of the basin for the state Ai being considered, the generalized Darcy's equation is solved. According to this implementation, a contribution of each migration mechanism modelled by the generalized Darcy's equation is determined, for each state Ai and in each cell of the gridded representation of the basin for the state Ai being considered.

More precisely, according to an implementation of the invention, in a cell of a gridded representation of a given state Ai, the contribution of the displacement of these hydrocarbons in the basin is determined under the effect of:
the hydrodynamic forces, according to a formula:

CH=grad(P−ρ_{w}gz)/U (2)
the capillary forces, according to a formula:

CC=grad(P_{c})/U (3)
the buoyancy (Archimedes' principle), according to a formula:

CF=(ρ_{w}−ρ)g·grad(z)/U (4)

where U is a rate of displacement of the hydrocarbon phase in the medium as described in Equation (1) above, P is the pressure of the water phase, ρw is the water density, ρ is the density of the hydrocarbon phase considered, z is the depth, Pc is the capillary pressure of the rock and g is the gravitational acceleration.

According to the invention, from the contribution of at least two of the hydrocarbon migration mechanisms in the basin for each state Ai and in each cell of the gridded representation of the basin for the state Ai considered, it is possible to determine a dominant hydrocarbon migration mechanism for one or more sets of cells of the gridded representation of at least one of a state Ai and a dominant hydrocarbon migration mechanism for states Ai. In other words, either spatial areas of the basin being studied for which one of the hydrocarbon migration mechanisms is dominant at a given geological time are determined, or time periods of the basin history for which one of the hydrocarbon migration mechanisms is dominant are determined, or spatial areas of the basin for which one of the hydrocarbon migration mechanisms is dominant during certain time periods of the history of the basin studied are determined.

In general, the information according to which hydrocarbon migration mechanism is dominant for at least one of a spatial area of the basin and during a time period of the basin history is particularly important because it allows better understanding of the events that have contributed to the formation of the sedimentary basin that is observed at the current time, and thus contributing to a better assessment of the petroleum potential of the basin being studied.

### 5. Calibration of the Basin Simulation Parameters

This step, which is optional, can be advantageously carried out within the context of the method according to a second aspect of the invention relative to a method of exploiting the hydrocarbons present in a sedimentary basin.

In general, the information according to which hydrocarbon migration mechanism is dominant for at least one of a spatial area of the basin and during a time period of the basin history is particularly important in a method of exploiting hydrocarbons present in a sedimentary basin implemented by use of a basin simulation because such methods often require launching numerical basin simulations, notably in order to calibrate the input parameters of the numerical basin simulation, such as the basin surface and basal temperatures, the pressures at edges of the geological model, petrophysical properties of the rocks or physico-chemical properties of the fluids. Indeed, it is conventional to launch numerical basin simulations by modifying the aforementioned input parameters until results of the numerical basin simulations (generally the result of the numerical simulation at the current time) are in accordance with the physical quantities measured in step 1, such as temperatures, densities, porosities or pressures.

According to an implementation of the invention, this step calibrates the parameters of the numerical basin simulation can be carried out by modifying the parameters of the numerical basin simulation until the differences between the gridded representation obtained in the current state by numerical basin simulation and the gridded representation of the basin in the current state obtained in step 1 above from physical quantity measurements are minimized. According to an implementation of the invention, an optimization algorithm, based for example on the conjugate gradient method, can be used to minimize in an automated manner, and according to an iterative process, an objective function measuring the differences between the measured values of the physical quantities and the estimated values of these physical quantities. Such an automated update of the numerical basin simulation parameters can be performed by use of the CougarFlow® software (IFP Energies nouvelles, France).

According to the invention, the information relative to at least one dominant migration mechanism for at least one a set of cells of a gridded representation and for at least one state Ai of the basin being studied can be useful in at least two ways, which may possibly be combined:
the information relative to a dominant migration mechanism is used to modify at least one parameter in particular of the numerical basin simulation. For example, if it appears that the contribution of the buoyancy-induced migration mechanism is dominant, the reaction products of the source rock maturation or the densities of the fluid fractions may be preferably selected from among the simulation parameters to be modified. According to another example, if it appears that the contribution of the migration mechanism induced by hydrodynamic forces is dominant, the parameters impacting the pressure regime, such as the rock permeabilities or the sedimentation rates, or even the secondary mineral transformations may be preferably selected from among the simulation parameters to be modified;
the information relative to a dominant migration mechanism is used, when a new numerical basin simulation is launched, to solve for at least one of the flows for this set of cells of a gridded representation and for at least one state Ai of the basin being studied only for the dominant mechanism thus identified. This allows to using simplified equations in relation to the generalized Darcy's equation, which are very costly in terms of computing time, and thus reducing the duration and the cost of a petroleum potential assessment phase for a sedimentary basin. For example, if it appears that the contribution of the buoyancy-induced migration mechanism is dominant, it is then possible to launch a basin simulation implementing a ray tracing method as described in the document (Sylta, 1991), which is less costly in terms of computing time than the solution of the complete generalized Darcy's equation. Similarly, if it appears that the hydrocarbon migration is predominantly conditioned by the capillary network of the pore medium, it is possible to use a migration model known as “invasion percolation”, also much faster than the solution of the complete Darcy's equation.

Thus, determining the dominant hydrocarbon migration mechanism(s) for one or more sets of cells of a gridded representation for at least one of in a given state Ai and the dominant hydrocarbon migration mechanism for states Ai of the basin allows at least one of modifying pertinent basin simulation parameters and to perform less computing time-consuming basin simulations that can thus be launched in larger numbers, which may contribute to a more precise calibration of the basin simulation parameters. A precisely calibrated basin model allows better understanding the events that have contributed to the formation of the sedimentary basin observed at the current time, and it therefore leads to a better petroleum potential assessment for the basin studied.

### 6. Exploiting the Hydrocarbons of the Sedimentary Basin

At the end of the previous steps, basin simulation results, preferably calibrated for the basin being studied, are available. The basin simulation according to the invention allows at least determination of the hydrocarbon migration in the basin in each cell of each of the gridded representations of the basin. In an implicit and conventional manner in basin simulation, the amount of hydrocarbons present in each cell of the gridded representation of the basin at the current time is also known.

Besides, depending on the basin simulator used for implementing the invention, the following information can for example be obtained:
i. the emplacement of the sedimentary layers,
ii. the compaction thereof under the weight of the overlying sediments,
iii. the heating thereof during burial,
iv. the fluid pressure changes resulting from burial,
v. the formation of hydrocarbons by thermogenesis,

From such information, it can then be determine for cells of the gridded representation of the basin at the current time comprising hydrocarbons, as well as the amount, the nature and the pressure of the hydrocarbons trapped therein. Areas of the basin being studied having the best petroleum potential can then be selected. These areas are identified as hydrocarbon reservoirs of the sedimentary basin being studied.

This step determines at least one exploitation scheme for the hydrocarbons contained in the sedimentary basin being studied. In general, an exploitation scheme comprises a number, a geometry and a location (position and spacing) of the injection and production wells to be drilled in the basin. An exploitation scheme can further comprise an enhanced recovery type for the hydrocarbons contained in the basin reservoir(s), such as enhanced recovery through injection of a solution containing one or more polymers, CO₂ foam, etc. An exploitation scheme of a hydrocarbon reservoir of a basin must for example allows having a high recovery rate for the hydrocarbons trapped in this reservoir, over a long exploitation time, and requires a limited number of wells. In other words, predefined evaluation criteria and used according to which an exploitation scheme for the hydrocarbons present in a reservoir of a sedimentary basin being considered to be efficient enough to be implemented.

According to an implementation of the invention, exploitation schemes are defined for the hydrocarbons contained in one or more geological reservoirs of the basin being studied and at least one evaluation criterion is estimated by use of a reservoir simulator (such as the PumaFlow® software (IFP Energies nouvelles, France)) for these exploitation schemes. These evaluation criteria can comprise the amount of hydrocarbons produced for each of the various exploitation schemes, the curve representative of the production evolution over time for each well being considered, the gas-to-oil ratio (GOR) for each well being considered, etc. The scheme according to which the hydrocarbons contained in the reservoir(s) of the basin being studied are really exploited can then correspond to the scheme meeting at least one of the evaluation criteria of the various exploitation schemes.

Then, once an exploitation scheme has been determined, the hydrocarbons trapped in the petroleum reservoir(s) of the sedimentary basin being studied are exploited according to this exploitation scheme, notably at least by drilling the injection and production wells of the exploitation scheme thus determined, and by setting up the production infrastructures necessary for developing this (these) reservoir(s). In cases where the exploitation scheme has further been determined by estimating the production of a reservoir associated with different enhanced recovery types, the type(s) of additives selected (polymers, surfactants, CO₂ foam) is injected into the injection well.

It is understood that an exploitation scheme for hydrocarbons in a basin can evolve over time during the hydrocarbon exploitation in this basin, depending for example on additional knowledge acquired on the basin during this exploitation, and improvements in the various technical fields involved in the exploitation of a hydrocarbon reservoir (improvements in the field of drilling, enhanced recovery for example).

Equipment and Computer Program Product

The method according to the invention is implemented by use of equipment (a computer workstation for example) comprising data processing means (a processor) and data storage means (a memory, in particular a hard drive), as well as an input/output interface for data input and method results output.

The data processing means are configured for carrying out in particular steps 2, 3 and 4 described above, as well as optional step 5.

Furthermore, the invention concerns a computer program product which is at least one of downloadable from a communication network, recorded on a nontransiently computer-readable storage medium and is processor executable, comprising program code instructions for implementing the method as described above, when the program is executed by a computer.

1-9. (canceled)

10. A computer-implemented method for determining a dominant hydrocarbon migration mechanism in a sedimentary basin, the sedimentary basin having undergone geological events defining a sequence of states of the basin, the sequence of states comprising the state of the basin at a current time and at least one state of the basin at a prior geological time, by use of a computer-performed numerical basin simulation, the numerical basin simulation simulating at least one migration of the hydrocarbons in the basin according to at least two migration mechanisms, the method comprising carrying out, with data processor, at least steps of:
A) performing measurements of physical quantities relative to the basin by sensors and constructing a gridded representation representative of the basin for the state of the basin at the current time;
B) using the gridded representation of the basin for the state of the basin at the current time to construct a gridded representation of the basin for each of the states of the basin at the prior geological times;
C) using the numerical basin simulation and of gridded representations for each of the states for determining, for each of the states and in each of the gridded representation of the state, a contribution of the migration mechanisms of the hydrocarbons in each cell for the state; and
D) determining therefrom at least one dominant migration mechanism of the hydrocarbons for at least one set of cells of at least one gridded representation of the basin for at least one of the states.

11. A method as claimed in claim 10, wherein the migration mechanism is induced by at least one of hydrodynamic forces, capillary forces and buoyancy.

12. A method as claimed in claim 10, wherein the numerical basin simulation implements a Darcy's equation to simulate the migration of the hydrocarbons in the basin, and the Darcy's equation is expressed with a formula:
$$U = \frac{- K , kr}{μ} [ grad ( P - ρ w gz ) + grad ( Pc ) - ( ρ w - ρ ) g \cdot grad ( z ) ]$$
where U is a rate of displacement of a hydrocarbon phase, K is an intrinsic water permeability, μ is a fluid viscosity, kr is relative permeability of the medium to the hydrocarbon phase, P is a pressure of a water phase, ρw is water density, ρ is density of the hydrocarbon phase, z is depth, Pc is capillary pressure and g is gravitational acceleration.

13. A method as claimed in claim 11, wherein the numerical basin simulation implements a Darcy's equation to simulate the migration of the hydrocarbons in the basin, and the Darcy's equation is expressed with a formula:
$$U = \frac{- K , kr}{μ} [ grad ( P - ρ w gz ) + grad ( Pc ) - ( ρ w - ρ ) g \cdot grad ( z ) ]$$
where U is a rate of displacement of a hydrocarbon phase, K is an intrinsic water permeability, μ is a fluid viscosity, kr is relative permeability of the medium to the hydrocarbon phase, P is a pressure of a water phase, ρw is water density, ρ is density of the hydrocarbon phase, z is depth, Pc is capillary pressure and g is gravitational acceleration.

14. A method as claimed in claim 12, wherein the contribution of one of the migration mechanisms induced by hydrodynamic forces is expressed with a formula:
CH=grad(P−ρ_{w}gz)/U.

15. A method as claimed in claim 13, wherein the contribution of one of the migration mechanisms induced by hydrodynamic forces is expressed with a formula:
CH=grad(P−ρ_{w}gz)/U.

16. A method as claimed in claim 12, wherein the contribution of one of the migration mechanisms induced by capillary forces is expressed with a formula:
CC=grad(P_{c})/U.

17. A method as claimed in claim 13, wherein the contribution of one of the migration mechanisms induced by capillary forces is expressed with a formula:
CC=grad(P_{c})/U.

18. A method as claimed in claim 14, wherein the contribution of one of the migration mechanisms induced by capillary forces is expressed with a formula:
CC=grad(P_{c})/U.

19. A method as claimed in claim 15, wherein the contribution of one of the migration mechanisms induced by capillary forces is expressed with a formula:
CC=grad(P_{c})/U.

20. A method as claimed claim 12, wherein the contribution of one of the migration mechanisms induced by buoyancy is expressed with a formula:
CF=(ρ_{w}−ρ)g·grad(z)/U.

21. A method as claimed claim 14, wherein the contribution of one of the migration mechanisms induced by buoyancy is expressed with a formula:
CF=(ρ_{w}−ρ)g·grad(z)/U.

22. A method as claimed claim 16, wherein the contribution of one of the migration mechanisms induced by buoyancy is expressed with a formula:
CF=(ρ_{w}−ρ)g·grad(z)/U.

23. A method of exploiting hydrocarbons present in a sedimentary basin, the method comprising implementing the computer-implemented method of determining a dominant hydrocarbon migration mechanism in the basin as claimed in claim 12 and wherein, from at least the dominant hydrocarbon migration mechanism, a scheme for developing the basin comprising at least one site for at least one of an injection well and at least one of production well is determined, and the hydrocarbons of the basin are exploited at least by drilling the wells at the site and providing the drilled wells with exploitation infrastructures.

24. A method as claimed in claim 23 wherein, from at least the dominant hydrocarbon migration mechanism, at least one of steps are further carried out:
a) use of a numerical basin simulation for simulating a migration of the hydrocarbons in the basin according to the dominant migration mechanism and from parameters of the basin simulation, determining basin simulation results as a function of the parameters of the basin simulation;
b) measuring differences between at least part of the results of the basin simulation at the current time and at least part of the measurements of the physical quantities at the current time; and
c) reiterating steps a) and b) until the differences are below a predetermined threshold, the parameters of the basin simulation are modified at each of the iterations of the reiteration of steps a) and b),
and wherein, additionally, from at least part of the results of the basin simulation, determining the development scheme of the basin is determined.

25. A computer program product which is at least one of downloadable from a communication network, recorded on a non-transient computer-readable medium and processor for executing, program code instructions for implementing the method of claim 10, when the program is executed by a processor.
